(19) United States
(12) Patent Application Publication
(10) Pub. No.: US 2014/0001764 A1
(43) Pub. Date: Jan. 2, 2014

(54) Human-Powered Electrical Generating Device

(71) Applicant: HUMANCAR, INC., (US)

(72) Inventor: Charles Greenwood, Cave Junction, OR (US)

(73) Assignee: HUMANCAR, INC., CAVE JUNCTION, OR (US)

(21) Appl. No.: 13/711,088

(22) Filed: Dec. 11, 2012

Related U.S. Application Data
(60) Provisional application No. 61/579,063, filed on Dec. 22, 2011.

(51) Int. Cl. H02K 7/18; F03G 5/08

(52) U.S. Cl. CPC H02K 7/1861; F03G 5/08
USPC 290/1 C

(57) ABSTRACT

An electrical power generating apparatus is defined by a human interface that is mechanically connected to power generating components. The arrangement of structural components in the human interface is made to convert and balance an oscillatory motion from one or plural human power sources along a first axis into rotational motion in the power generating equipment. The oscillatory motion is converted to rotational motion that is output for useful work, and in particular, the generation of electrical current.

### TECHNICAL FIELD

The present invention relates to human-powered devices and the mechanical interfaces between humans and machines, and more specifically relates to a portable human-powered electrical generator with special features that make it more practical and efficient than other previous similar devices.

### BACKGROUND

Human-powered apparatus are used in many different endeavors. They may be used to teach teamwork skills, to provide strength training, and to provide other tangible benefits such powering modes of transportation such as bicycles. And human power may be used for many different purposes. These range, as noted, from human-powered modes of transportation such as bicycles and the like, to human-powered apparatus used to generate secondary power such as emergency electrical generation equipment. The efficiency with which human power is converted to mechanical power can be measured in many different ways. For example, the efficiency with which a mechanical device, such as a bicycle, converts human power (measured in, for instance, wattage output) to mechanical power can be measured and quantified fairly easily and accurately. But as mechanical design takes into account principles of ergonomics, mechanical devices tend to be more “user friendly” and comfortable, which also makes their use more efficient. This is a more subjective but no less important measure of the “efficiency” of a power-converting device. But regardless of what yardstick is used to measure efficiency, it is true that the more efficiently human power output is translated into mechanical output, the less work the human has to perform to generate mechanical power.

Human-powered vehicles such as bicycles and many less traditional human-powered vehicles offer many benefits to their users. For instance, not only can such vehicles provide an efficient mode of transportation, but they can also be enjoyable as recreational devices. As energy resources, such as petrochemicals that are used to power internal combustion engines, become more and more scarce, alternate sources of transportation become more important. And the problems associated with environmental pollution need no explanation. Human-powered vehicles thus solve many of the problems associated with vehicles powered by internal combustion engines.

The lessons learned from human-powered modes of transportation may be successfully translated into other human-powered devices designed to produce useful work. For example, the most common human powered electrical generator is the combination of a bicycle wheel driving a small wheel mounted to the shaft of a permanent magnet direct current generator. Although such devices are fairly common, they embody numerous known disadvantages, including:

a) Bicycle drive arrangements must be properly fit to the human form or repetitive stress injuries can occur, and in any case the high stress created at the rider's crotch can become uncomfortable and ultimately debilitating. Prostate and testicular cancers in professional riders are not unheard of, as well as knee replacement surgeries and so on.

b) The amount of useful power from such an arrangement is limited by the leg strength of the rider. Exercise in this manner will produce robust leg muscles but little development of other available muscles.

c) If numbers of people are available to operate such a device at the same time, then a larger and more efficient generator may be employed. Very small generators are difficult to make highly efficient due to the constraints of physics. Making a more complex device powered from a multiplicity of riders allows the use of a larger and more efficient generator, but the added complexity of the arrangement may be impractical.

d) If numbers of people are available to operate such a device one after the other, adjustments will have to be made to properly fit the mechanism to each individual. This takes time and adds complexity.

There have been numerous attempts to harness other muscle inputs to create electrical generation, including walking, moving your arms, and so on, but these all suffer from extremely low power output (a few watts to tens of watts) and relatively high complexity.

There are many other examples of devices intended to create and/or harness power that is generated by human activity. For example, a stairway at a busy subway station has been outfitted with piezoelectric compressions strips so that when people step down the stairway a tiny amount of power is harvested with each step. Light switches have utilized similar technology to generate just enough power to cause a radio signal to be sent to a remote device in a light fixture, allowing control of the fixture without installing wiring or using batteries. And dancers jumping up and down on similar material can generate enough power to cause a small light to turn on. All of these examples, while interesting, do not provide useful amounts of power without requiring a great deal of complexity.

There is a continuing need for a practical human powered generator that provides useful electrical power while utilizing most of the muscles in the human body.

### SUMMARY OF THE INVENTION

The present invention relates to power generating equipment that is mechanically interfaced with human-operated structures. The arrangement of structural components in the human interface is made to convert and balance an oscillatory motion from one or plural human power sources along a first axis into rotational motion in the power generating equipment. The oscillatory motion is converted to rotational motion that is output for useful work, and in particular, the generation of electrical current.

The invention described herein offers multiple advantages over known human-powered electricity generating devices such as those described above. First, although it is operable with a single user, the invention allows for plural participants to combine their power output in coordinated movement. Second, because in a preferred embodiment the device has no engine (other than the operators), the device is non-polluting and relies only upon its operators for a power source rather than independent fuel sources. Third, because the occupants are able to coordinate their power input through coordinated motion/exercise, the device generates power more efficiently because the operators are working together as a team. In a significant sense, therefore, the invention serves as a highly effective training apparatus that teaches behaviors that are necessary to effective group activity. Fourth, the invention provides an efficient method of providing physical conditioning.

The invention takes into account the fact that not all who use it are physically capable of outputting the same amount of power. As such, each participant may contribute to the team effort according to his or her individual abilities. The power output of each participant is coupled with the power output by the others to provide efficient power pulses. Regardless of whether the apparatus uses the power of one, two, three, four or more operators, each participating in operating the device typically must exert physical exercise, although even when one or more participants is participating passively the device utilizes that participant's mass to the benefit of the remaining team members.

The present invention utilizes machinery and electrical components in a novel way that allows a person or a group of persons to:

a) simply step on to the included platform and push and pull a lever;

b) sit on seats provided in a variety of alternate mechanisms and push and pull a system of levers and linkages.

The advantages of this arrangement include:

a) for most people, no adjustment of the mechanism is required to achieve proper biomechanical interface. If adjustment is required, it is provided by one simple adjustment of the vertical lever shaft;

b) The amount of useful power from such an arrangement allows most muscles in the human body to produce useful power. By pushing while stepping forward and pulling while stepping backward complete exercise is provided. Two people can operate the device at the same time without adding any additional mechanisms;

c) The arrangement can be expanded without adding greatly to the complexity so as to allow numerous people to operate the device at the same time. Producing higher levels of power than a bicycle arrangement allows the use of a larger and more efficient generator;

d) This Invention also provides for interface to a recumbent biomechanical interface as described in U.S. Pat. No. 6,328,325 “Teamwork and Strength Training Apparatus”, the disclosure of which is incorporated herein by reference.

Several possible arrangements are shown on the drawings accompanying this specification and in the descriptions below.

### BRIEF DESCRIPTION OF THE DRAWINGS

The invention will be better understood and its numerous objects and advantages will be apparent by reference to the following detailed description of the invention when taken in conjunction with the following drawings.

The illustrations of FIGS. 1, 2 and 3 show three different “interfaces” that human operators may use to operate the power-generating apparatus according to the present invention. In each of these figures the power-generating apparatus is the same; the interface varies in each of the drawings. More specifically:

FIGS. 1A and 1B are side elevation views of first and second illustrated embodiments of a human-powered electrical generating device according to the present invention.

FIG. 1A: In the upper illustration of FIG. 1A—the first embodiment—the two human operators are seated in a back-to-back orientation.

FIG. 1B: in the lower illustration of FIG. 1B—the second embodiment—the two operators are seated in a face-to-face orientation.

FIGS. 2A, 2B and 2C are a series of three side elevation view illustrations of a third embodiment of a human-powered electrical generating device according to the present invention. In this series the human operators are shown operating the device in a standing, face-to-face position. The motion of the operators as the apparatus is operated to generate electricity is illustrated in the three sequential illustrations of FIG. 2A, FIG. 2B and FIG. 2C.

FIG. 2A: in the upper illustration of FIG. 2A the operators are shown operating the device in a standing, first face-to-face position;

FIG. 2B: in the middle illustration of FIG. 2B the operators are shown operating the device in a standing, second face-to-face position;

FIG. 2C: in the lower illustration of FIG. 2C the operators are shown operating the device in a standing, third face-to-face position.

FIGS. 3A and 3B are side elevation views of a fourth illustrated embodiment of the device according to the present invention in which the operators are sitting in-line and facing in the same direction, one in front of the other, in the manner of a double-crew rowing machine.

FIG. 3A: the operators are in a first position;

FIG. 3B the operators are in a second position in the operational cycle.

FIGS. 4A, 4B and 4C are a series of side elevation views of the power-generating components of the present invention shown in isolation without the human interface structures. More specifically, in the series of drawings of FIGS. 4A, 4B and 4C the operation and movement of the power-generating components, in which lateral motion caused by oscillation of the handles by the operators is translated to rotational motion of the crankshaft, is illustrated sequentially beginning with FIG. 4A and going from left to right, to FIGS. 4B and 4C.

FIG. 4A: the power-generating components of the present invention shown in a first position;

FIG. 4B: the power-generating components of the present invention shown in a second position;

FIG. 4C: the power-generating components of the present invention shown in a third position.

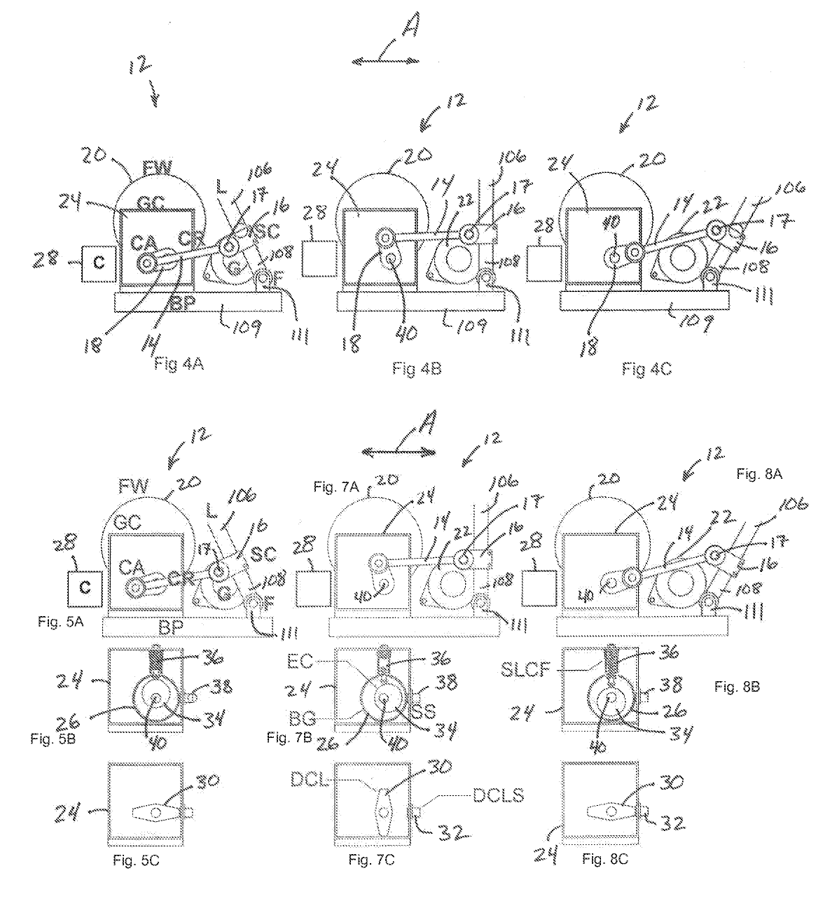

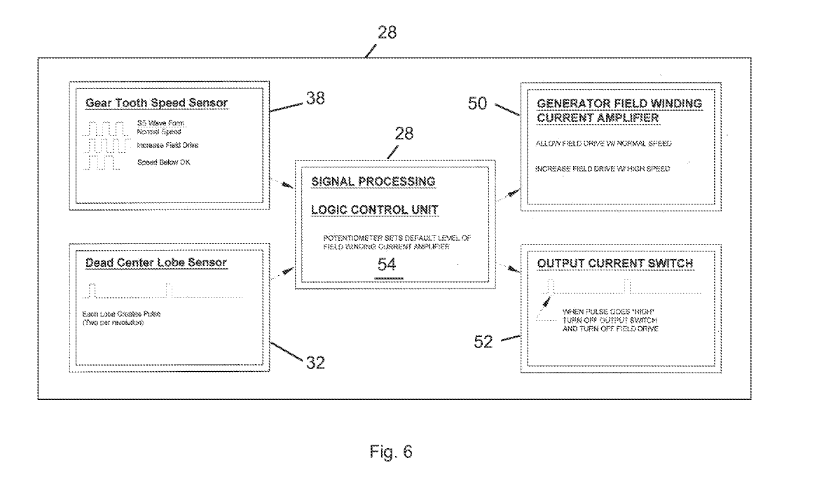

The series of illustrations in FIGS. 5, 7 and 8 is similar to the series of FIG. 4 except the drawings of FIGS. 5, 7 and 8 include a cutaway views showing selected components in the interior of the gear case to illustrate the relative positions of the internal components as they move through the operational cycle. The top row of drawings in FIGS. 5, 7 and 8 are the same as the drawings of FIGS. 4A and 4B; the middle row in FIGS. 5, 7 and 8 illustrates select components of the interior of the gear case in the relative positions indicated by the top row; and the lower row in FIGS. 5, 7 and 8 shows the interior of the gear case with the bull gear and eccentric cam removed to illustrate the dead center lobe and its movement through the operational cycle.

FIG. 5A: the power-generating components of the present invention shown in a first position;

FIG. 5B: select components of the interior of the gear case are shown in the relative positions indicated by the top row, FIG. 5A;

FIG. 5C: illustrates the interior of the gear case with the bull gear and eccentric cam removed to illustrate the dead center lobe and its movement through the operational cycle.

FIG. 6 is a block diagram showing the electronic and control mechanism of the present invention.

FIG. 7A: the power-generating components of the present invention shown in a second position;

FIG. 7B: select components of the interior of the gear case are shown in the relative positions indicated by the top row, FIG. 7A;

FIG. 7C: illustrates the interior of the gear case with the bull gear and eccentric cam removed to illustrate the dead center lobe and its movement through the operational cycle;

FIG. 8A: the power-generating components of the present invention shown in a third position;

FIG. 8B: select components of the interior of the gear case are shown in the relative positions indicated by the top row, FIG. 8A;

FIG. 8C: illustrates the interior of the gear case with the bull gear and eccentric cam removed to illustrate the dead center lobe and its movement through the operational cycle.

### DETAILED DESCRIPTION OF ILLUSTRATED EMBODIMENTS

The inventions are described herein embodied with several different configurations of human interfaces through which one or more people operate the apparatus in order to generate electricity. In its most basic configuration, therefore, the invention is defined by power generating equipment that is mechanically and operably coupled to a human interface. The operators perform work on the interface to in turn cause work to be done on the power generating equipment and to thereby generate power, typically in the form of electricity. Although there are several different configurations of the structures that define the human interface, it will be appreciated that those of skill in the art will be able to design other equivalent structures.

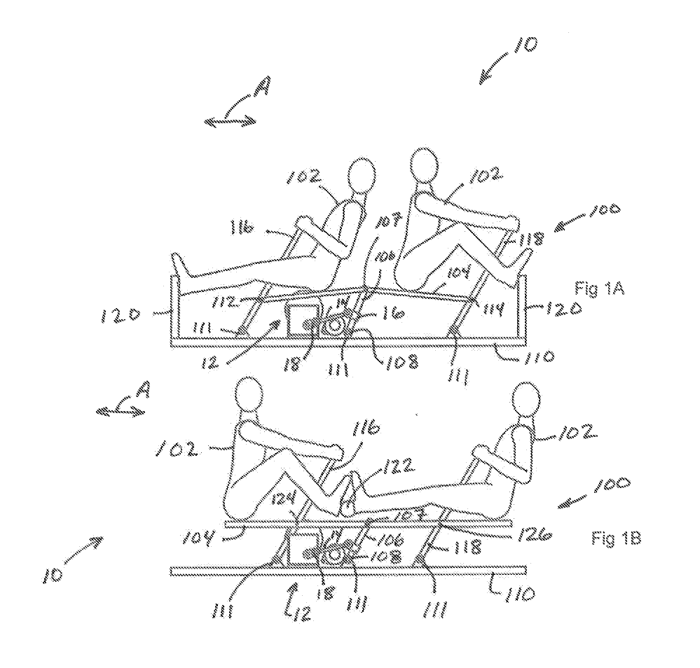

With reference now to FIGS. 1A and 1B, apparatus 10 is generally defined by two components, power generating equipment 12 and a human or operator interface 100. Each of these components is described in detail below beginning with the operator interface 100. For clarity, like structures in different figures are identified with the same reference numbers.

As noted previously, there are numerous configurations of an operator interface 100 that may be used to couple human work to the power generating equipment 12. In FIG. 1A the upper of the two figures shows two operators 102 (i.e., humans) in seated positions on a seat platform 104 that is common to both operators. Said another way, both operators are seated on a common seat platform 104. Although dedicated seats are not shown in the drawings, it will be appreciated that the comfort and efficiency of the apparatus may be improved by providing seats. Seat platform 104 is supported by a central support arm 106 that has its first or upper end 107 pivotally attached to a central portion of the seat platform 104 approximately midway between the locations where the two operators are seated and the lower end 108 is pivotally attached to a base 110, for example, with a pivotal bracket 111. As detailed below, the attachment of the lower end 108 of central support arm 106 to base 110 at bracket 111 defines a fulcrum point about which the seat platform 104 oscillates. The outer opposite ends of the seat platform 104, labeled 112 and 114 in the drawings, are supported by elongate handles 116 and 118, respectively. Specifically, the lower ends of the handles 116 and 118 are pivotally attached to base 110 with pivotal brackets 11 and the seat platform 104 is pivotally attached to the handles at a mid-point along the length of the handles. The upper portion of the handles—the portion extending above the seat platform 104, defines handles that the operators 102 may grasp while operating apparatus 10.

A foot brace 120 is attached to the base 110 at locations such that each operator 102 may brace his or her feet against the foot brace 120 to provide a mechanical advantage while apparatus 10 is operated.

As detailed below in respect of the power generating equipment 12, a connecting rod 14 has one end attached to central support arm 106 at a sliding connection bracket 16 and its opposite end attached to a crank arm 18.

With the lower ends of the handles 116 and 118 pivotally mounted to frame 110, the handles 116 and 118 pivotally mounted to the seat platform 104, and the pivotally mounted central support arm 106, it will be clear that the seat platform 104 is movable about its pivotal attachment points in a back and forth oscillatory motion along an axis parallel to a longitudinal frame axis, as indicated with arrow A in FIG. 1A. As the operators 102 pull and push, respectively, on handles 116 and 118, aided by their legs which are braced against foot braces 120, the seat platform 104 oscillates back and forth—stops may be included to limit the travel of the seat platform although the connection at sliding connection bracket 16 and its attachment to crank arm 14 naturally limits the travel. As the platform oscillates, connecting rod 14 causes rotation of crank arm 18, which as detailed below, causes the generation of electricity.

The lower of the two illustrations in FIG. 1, that is, FIG. 1B, shows a second embodiment of a human interface 100 that has the exact same operational features but in which the two operators 102 are facing one another. In this case, the foot braces 120 may be omitted and replaced by a foot brace 122 that is positioned between the operators and fixed relative to base 110. In addition, the points of attachment of the handles 116 and 118 to seat platform 104 in the embodiment of FIG. 1B is moved inward relative to the upper drawing of FIG. 1A so that the handles are appropriately located between the operators 102. In FIG. 1B these pivotal attachment points are labeled with reference numbers 124 and 126, respectively.

It will be appreciated that the operational characteristics of the second embodiment—FIG. 1B are identical to those of the first embodiment of FIG. 1A: As the operators 102 pull and push, respectively, on handles 116 and 118, aided by their legs which are braced against foot brace 122, the seat platform 104 oscillates back and forth—arrow A. As the platform oscillates, connecting rod 14 causes rotation of crank arm 18 to translate the lateral oscillating motion of the seat platform into rotational motion, which in turn causes the generation of electricity.

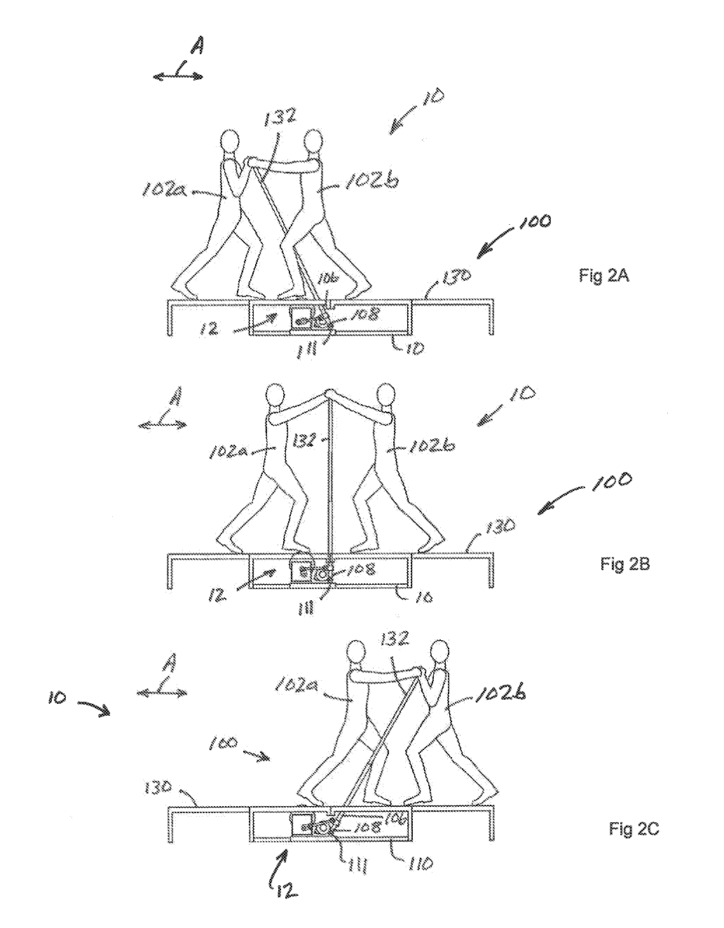

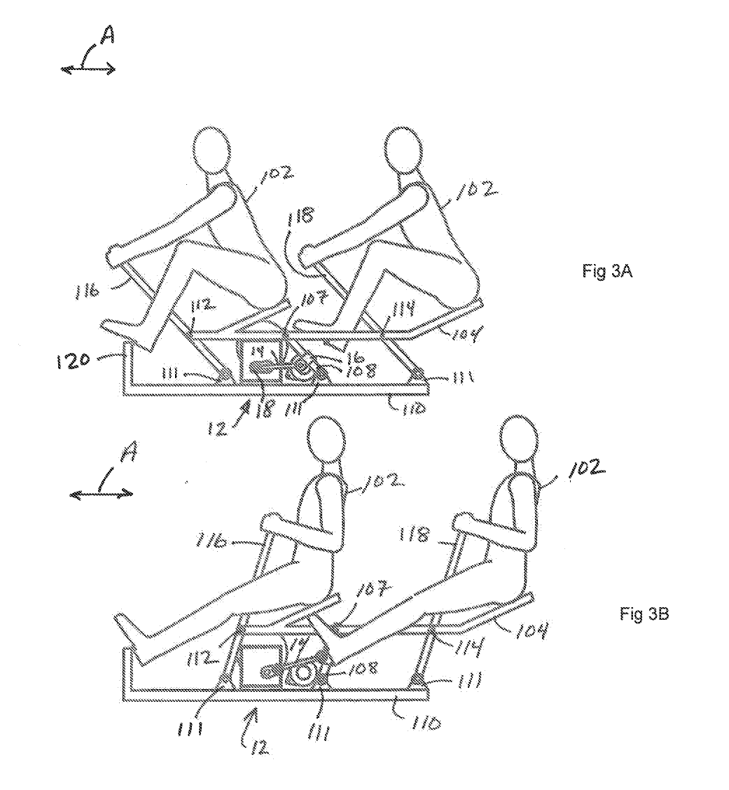

FIGS. 2 and 3 illustrate two additional embodiments of human interfaces 100 that may be used with the identical power generating equipment 12 that are shown in FIGS. 1A and 1B. With reference to the series of three drawings of FIG. 2, the humans 102a and 102b are shown in an upright standing position, standing on a platform 130 and there is a single handle 130 positioned between the operators. The power generating equipment 12 in FIG. 2 are identical to those shown in FIG. 1 and are detailed below. The platform 130 is fixed and supports the weight of the operators 102. The handle 130, which is relatively longer than the handles 116 and 118 of FIG. 1 so that the standing operators have more to grab onto, has its lower end 108 pivotally attached to base 110 at a bracket 111.

The back and forth oscillating motion of the operators driving handle 132 is evident from the series of images in FIG. 2A, moving to FIG. 2B and then to FIG. 2C. Thus, as the operator on the left in FIG. 2A, 102a, pushes handle 132 forward (i.e., to the right in FIG. 2A) toward the operator on the right, 102b, using his or her arms and legs, the operator on the right 102b pulls backwardly, toward the right in the figure and away from the operator 102a on the left. The operators step forward and back as needed for both strength and balance. In the middle figure of FIG. 2B, the handle 132 is essentially vertical in the middle of the operational cycle and the two operators are moving from left to right—the operator 102a on the left is stepping forward and pushing on handle 132 and the operator on the right 102b is stepping back and pulling on the handle. The third drawing in the sequence, FIG. 2C, shows the operators 102 in the opposite position as FIG. 2A. FIGS. 2A and 2C thus represent the opposite ends of the operational cycle. The arrows A show the back and forth direction of oscillation caused by the motion of the operators 102.

With reference now to FIG. 3, the apparatus 10 is adapted with yet another human interface 100 in which the two operators 102 are seated fore and aft relative to one another in the manner of a rowing machine. Again, the components of the power generating equipment 12 are identical to those shown in FIGS. 1 and 2.

With each of the human interfaces illustrated in FIGS. 1, 2 and 3, the various components may be adjustable to accommodate the size of the operators. It will be appreciated, too, that each apparatus 10 may be operated by a single operator, by two operators, or additional stations may be added to add additional people to participate.

The power generating equipment 12 and its mechanical couplings to the human interfaces 100 will now be detailed with specific reference to the series drawings of FIGS. 4 and 5.

As a naming convention, the drawings of FIGS. 4 and 5 include in some instances both letter abbreviations and numerical identifiers to represent the same structure. A key to those abbreviations and numerical identifiers is provided below in Table 1 for reference.

TABLE 1

| Reference | Alphabetical | Identified | |
|---|---|---|---|
| Number | Abbreviation | Structure | Basic operational function |
| 109 | BP | Base plate | Provides mechanical mounting and |
| | | | connections |
| 18 | CA | Crank arm | Rotates about crankshaft |
| 14 | CR | Connecting rod | Attaches the crank arm to the sliding |
| | | | connection on the handle |
| 111 | F | Fulcrum | Point of rotation for handle |
| 20 | FW | Fly wheel | Provides angular momentum at the |
| | | | highest speed shaft in the gear train |
| 22 | G | Generator | Driven by fly wheel to produce |
| | | | electrical output |
| 24 | GC | Gear case | Provides a housing and mounting |
| | | | structure for internal and external |
| | | | components |
| 106 | L | Lever (also | Extends upwardly from base to |
| | | handle) | establish oscillating connection to |
| | | | human interface |
| 16 | SC | Sliding | Established the point of oscillation for the |
| | | connection | driven end of the connecting rod |
| | | bracket | |
| 26 | BG | Bull gear | Main toothed gear element receiving |
| | | | maximum torque |
| 28 | C | Controller | Control electronics and |
| | | | microprocessors |
| 30 | DCL | Dead center lobe | Rotates with the input shaft and |
| | | | triggers the sensor DCLS |
| 32 | DCLS | Dead center lobe | Establishes a signal input to the control |
| | | sensor | electronics and microprocessors |
| 34 | EC | Eccentric cam | Rotates with the input shaft and |
| | | | compresses the energy storage spring |
| 36 | SLCF | Spring loaded | Stores energy when compressed |
| | | cam follower | |
| 38 | SS | Speed sensor | Provides a signal to the control |
| | | | electronics when each gear tooth of |
| | | | bull gear 26 passes by; also referred to |
| | | | as Gear Tooth Speed Sensor |

With reference now to FIG. 4, the support arm 106 defines the lever that pivots about the fulcrum at bracket 111 as the human operators move the handles (or handle, as the case may be) through the operational cycle. For example, the position of lever 106 in FIG. 4A corresponds to the position of the apparatus 10 in FIG. 2A; the position of lever 106 in FIG. 4B corresponds to the position of the apparatus 10 in FIG. 2B, and the position of lever 106 in FIG. 4C corresponds to the position of the apparatus 10 in FIG. 2C. The back and forth, lateral oscillation of lever 106 (arrow A) drives connecting rod 14, which is pivotally attached on its driven end 17 to sliding connection bracket 16 and its opposite end to crank arm 18—the sliding connection bracket 16 is normally fixed to the lever 106 but is adjustable on it. At the same time, the connecting rod 14 drives crank arm 18 in a rotational motion. It will be evident therefore that as the operators 102 (e.g., FIGS. 2A, 2B and 2C) move through repeated operational cycles, the oscillating movement of the lever 106 is translated into rotational movement of the crank arm 18.

With reference to FIGS. 4 and 5, crank arm 18 is fixed to and rotationally drives a drive shaft 40 in gear case 24 and on which bull gear 26 and eccentric cam 34 are mounted. As is the case for all reciprocating and oscillating systems, there is a point at each end of the travel where the mechanism is at “dead center” and may become locked as the collected forces are in balance about the centerline of the rotating (primary) shaft and therefore no motion will occur with any amount of force. Indeed, this is why combustion engines have starters and further rely on rotating inertia (flywheels) to carry them through the dead centers that occur twice in each revolution of the rotating shaft. In addition, it will be appreciated that with a system such as apparatus 10 that is driven by human operators who may have differing strength and endurance capabilities, forces in once direction may be much greater than the forces in the opposite direction. While all of the previous configurations attempt to balance the forward and backward forces, in practice it is difficult to find two operators who can balance these forces with any precision.

The power generating equipment 12 is shown at one dead center FIG. 4A, and another, opposite dead center in FIG. 4C, while one of two (the upper) connecting rod 14 positions is shown mid-stroke in FIG. 4B. The location of the fulcrum defined by bracket 111 may be adjusted laterally and the sliding connection bracket 106 may be adjusted up and down the lever 106. These multiple adjustment parameters provide for variable oscillation travel of the lever 106 without requiring any changes in any of the other components.

Any type of standard drive such as a belt to name one example may connect the fly wheel 20 to the generator 22. The generator 22 may of course be located inside of the gear case 24 but is shown externally for the sake of clarity.

With continuing reference to FIG. 5, select components of power generating equipment 12 that are located inside of the gear case are detailed next. To optimize functionality and efficiency of apparatus 10, the generator current 24 is controlled by a variety of sensors including dead center lobe sensor 32 and speed sensor 38, both of which are electrically interfaced with and in communication with controller 28, which is comprised of microprocessors and associated control software and which while optional is a preferred component of the apparatus. The bull gear 26 and speed sensor 38 provide a pulsed signal to the electronics of controller 28 by sensing the movement of gear teeth (of bull gear 26) past the sensor (or any arrangement of gear teeth and sensors further up the drive drain). This function prevents the generator 24 from loading down the mechanism until the speed has become greater than a pre-determined minimum rotational speed that is programmed into the controller 28. A second function is to increase the load from the generator 24 when the rotational speed is greater than a pre-determined nominal value.

The intermediate row of drawings in FIGS. 5A, 5B and 5C illustrate the bull gear 24, eccentric cam 34 and the spring loaded cam follower 36 as the apparatus moves through the operational sensor between opposed dead center positions—the drawings correspond to the drawings immediately above and below them in the figures. In FIG. 5A the lever 106 is at the end of its lateral stroke and the apparatus is at a first dead center position. In this position the eccentric cam 34 has compressed the spring loaded cam follower 36 to the maximum and the amount of stored energy in the spring of the cam follower is at a maximum. In FIG. 5B the lever is mid-stroke and the spring loaded cam follower 36 is releasing its energy as the spring decompresses. In FIG. 5C the lever is at the opposite end of the stroke and the power generating equipment 12 is at the opposite or second dead center position. Again, spring loaded cam follower 36 is compressed to its maximum. The cam follower 36 is preferably a low friction apparatus designed to minimize the force required to push the rotation of shaft 40 as the spring returns to its minimized compression state.

In the lowermost drawings of FIGS. 5A, 5B and 5C the bull gear 24, eccentric cam 34 and spring loaded cam follower 36 are removed to expose the dead center lobe sensor 38 and the dead center lobe 30, which is fixed to drive shaft 40 and is therefore rotatable therewith. As the drive shaft 40 rotates, the opposite ends of the dead center lobe 30 pass closely by the dead center lobe sensor 32. As is clear from the drawings, the opposite ends of the dead center lobe 30 are oriented at 180 degree intervals. Therefore, with each complete 360 degree rotation of the drive shaft 40, the dead center lobe 30 passes by sensor 32 (and two signals are thus sent to the controller for each rotation of the shaft).

The dead center lobe sensor 32 is functionally the same type of sensor as the speed sensor 38, but actuates only when the crank arm 18 approaches dead center and dead center lobe 30 is in the corresponding position, and as detailed below, thereby de-activates the generator 24 load momentarily from the mechanism. This allows the use of a fly wheel 20 that has just enough rotating mass to help the components of the power generating equipment 12 through the two dead center positions. By adjusting the exact relationship between the geometry of dead center lobe 30 to the shaft and dead center lobe sensor 32, a single sensor is capable of providing the de-activating function at each of the two dead center positions.

It is very desirable to have the mechanism return to a consistent point of beginning, and this is accomplished by using the eccentric cam 34 that is attached to the drive shaft 40 in conjunction with a suitable low friction spring loaded cam follower 36. Provided that the energy stored in the spring loaded cam follower 36 is sufficient to push the eccentric cam 34 to its point of least compression, then the mechanism will return to the desired location.

It will be appreciated that if weight, space, and cost were no object, the functionality described above with respect to the eccentric cam 34 could be accomplished by the use of a heavy connecting rod along with an external spring that would help to pull the mechanism back to its initial position, while a heavy flywheel would assist the mechanism to travel through its dead centers. This would functionally be similar to the classic 19^{th} century railroad maintenance “velocipede” known commonly as the “hand car”. However, the structures described above greatly minimizes the weight, space and cost of providing this functionality, and in addition provide multiple control inputs to the control electronics so that overall functionality and efficiency is greatly improved.

FIG. 6 is a block diagram that illustrates show the electronic and control mechanism of the present invention as embodied in the various sensors and in controller 28. Controller 28 is a conventional microprocessor that utilizes appropriate software and firmware and control electronics for the tasks it performs. Since the operational output of apparatus 10 is under the control of controller 28, the controller 28 is shown around the entire control mechanism in FIG. 6 as wells as being the signal processor and logic control unit 28. The block around the other blocks in FIG. 6 is a schematic representation of the overall control function provided by controller 28.

Speed sensor 38 and dead center lobe sensor 32 outputs signal to controller 28. Specifically, speed sensor 38 transmits a signal to the controller each time a gear tooth of bull gear 26 passes by the sensor. Three signal or wave forms are shown in FIG. 6:

a) normal speed (a predetermined speed that is preset and saved in controller 28);

b) increased field drive (i.e., speed greater than normal speed); and

c) less than normal speed.

The signal generated by the sensor 38 is transmitted to the controller.

Dead center lobe sensor 32 transmits two signal pulses to controller 28 with each revolution of the dead center lobe—a signal is transmitted whenever the apparatus 10 is at one of the dead center points as detailed above. The signals from speed sensor 38 and dead center lobe sensor 32 are processed by controller 28, which then controls via output signals the generator field winding current amplifier 50 and output current switch 52. As illustrated in FIG. 6, a potentiometer 54 under the control of controller 28 sets the default level of the generator field winding current amplifier 50 and allows field drive with normal speed and increased field drive with increased speed (that is, speed higher than the predetermined normal speed). The output current switch 52 momentarily deactivates the generator load when pulses are received from the dead center lobe sensor 32 (as processed by the controller 28 and transmitted to the output current switch 52 by turning off the output switch and field drive.

To be useful, apparatus 10 described herein needs to be able to function with a variety of generating devices, including permanent magnet DC (PMDC), brushless direct current (BLDG), synchronous AC including single and multi-phase configurations, and with additional electronics AC induction machines.

The block diagram of FIG. 6 provides a method of interrupting the connection between the generator and the load when

a) the mechanism is not rotating quickly enough to do any work (i.e., when the speed is less than the preset, predetermined normal), and

b) every time the mechanism goes through a dead center (via the output current switch).

In addition, if the operators have enough power to speed the rotation above a predetermined set point, then the field current is increased to cause the output of the generator to go up as well. For pure DC machines another necessary requirement is to sense the direction of the rotation and to prevent “negative generation” with a shaft rotational direction sensor.

While the present invention has been described in terms of preferred and illustrated embodiments, it will be appreciated by those of ordinary skill that the spirit and scope of the invention is not limited to those embodiments, but extend to the various modifications and equivalents as defined in the appended claims.

1. A human-powered electricity generating device, comprising:
an electricity generating device that includes a generator;
at least one handle connected to the electricity generating device and pivotally attached to a base for oscillatory movement so that oscillatory movement of the at least one handle is translated into rotational movement of a shaft in the electricity generating device, said at least one handle accessible for oscillatory movement by at least one human.

2. The human-powered electricity generating device according to claim 1 wherein the at least one handle extends through a platform adapted for accommodating at least two humans in standing positions on both sides of said at least one handle.

3. The human-powered electricity generating device according to claim 1 including at least two handles, each connected to the electricity generating device and pivotally attached to a base for synchronized oscillatory movement so that synchronized oscillatory movement of the at least two handles is translated into rotational movement of the shaft in the electricity generating device.

4. The human-powered electricity generating device according to claim 3 wherein each of the handles in the at least two handles is coupled to a seat and wherein oscillatory movement of a handle is coupled to oscillatory movement of the seat.

5. The human-powered electricity generating device according to claim 1 further including a fly wheel attached to a shaft in the electricity generating device and a sensor for detecting when oscillatory movement of the handle causes the electricity generating device to reach a dead center point.

6. The human-powered electricity generating device according to claim 5 wherein when the sensor sends a signal to a controller and the controller deactivates the electricity generating device for a predetermined period when the electricity generating device reaches a dead center point.

7. The human-powered electricity generating device according to 6 including:
an eccentric cam on the shaft;
a spring-loaded cam follower in contact with the eccentric cam so that the spring is compressed and expanded by rotation of the shaft and the eccentric cam, and wherein the spring in the most highly compressed condition exerts enough spring force on said eccentric cam to force the shaft to rotate.

8. The human-powered electricity generating device according to claim 7 including a dead center lobe attached to the shaft and rotatable therewith, said dead center lobe having opposed ends, wherein each of the opposite ends interacts with the sensor when the dead center lobe rotates and said ends pass by the sensor as the shaft rotates to thereby generate the signal.

9. The human-powered electricity generating device according to claim 8 including a speed sensor in communication with the controller to detect the rotational speed of the shaft.

10. The human-powered electricity generating device according to claim 9 including a bull gear fixed to the shaft and wherein the speed sensor detects rotation of the bull gear.

11. A human-powered electricity generating device, comprising:
an electricity generating device;
at least one human interface defining a connection to the electricity generating device through which physical motion of a human operator causes an oscillatory movement that is translated into rotational movement of a shaft in the electricity generating device.

12. The human-powered electricity generating device according to claim 11 wherein the at least one human interface is defined by a seat platform adapted for accommodating at least two human operators, said seat platform pivotally supported for oscillating movement, and including at least two handles, one for reach of the at least two human operators, wherein rotational movement of the shaft in the electricity generating device is caused by oscillating movement of the seat platform.

13. The human-powered electricity generating device according to claim 12 wherein the seat platform is supported by a central support near a center point of said seat platform and two handles that are pivotally attached to and support said seat platform on opposite sides of said center point.

14. The human-powered electricity generating device according to claim 13 including a connecting rod attached to the central support and the electricity generating device so that oscillating movement of the seat platform is translated to rotational movement of the shaft.

15. The human-powered electricity generating device according to claim 11 wherein the at least one human interface is defined by a least one handle that is pivotally attached to a base and extends through a platform supported above the base, and wherein the handle is adapted for accommodating at least one human operator in standing position on the platform, and a rod interconnecting the handle to the shaft of the electricity generating device, wherein movement of the at least handle by a human operator causes rotation of the shaft.

16. A human-powered electricity generating device, comprising:
an electricity generating device having a shaft with an eccentric cam fixed thereto for direct rotation therewith, a spring-loaded cam follower in contact with the eccentric cam so that the spring is compressed and expanded by rotation of the shaft and the eccentric cam, wherein the spring in the most highly compressed condition exerts enough spring force on said eccentric cam to force the shaft to rotate to the rotational position in which the spring is in its least compressed position;
a sensor for detecting the rotational position of the shaft;
a sensor for detecting the rotational speed of the shaft; and
at least one handle connected to the electricity generating device and pivotally attached to a base for oscillatory movement so that oscillatory movement of the at least one handle is translated into rotational movement of a shaft in the electricity generating device, said at least one handle accessible for oscillatory movement by at least one human.

17. The human-powered electricity generating device according to claim 16 wherein the at least one handle is movable through an oscillatory cycle that has a dead center point at the opposite ends of each oscillatory cycle, and including a controller in communication with the sensors, wherein the controller correlates the position of the at least one handle at each dead center point to the rotational position of the shaft and the controller deactivates the electricity generating device at each of said dead center points.

18. The human-powered electricity generating device according to claim 17 wherein the controller deactivates the electricity generating device for a predetermined period at each of said dead center point.

19. The human-powered electricity generating device according to claim 17 including a generator, wherein the controller interrupts the output of the generator when the rotational speed of the shaft is below a predetermined minimum.

20. The human-powered electricity generating device according to claim 16 including a direction sensor for detecting the rotational direction of the shaft.
